(19) United States
(12) Patent Application Publication
(10) Pub. No.: US 2010/0269433 A1
(43) Pub. Date: Oct. 28, 2010

(54) Buck system

(76) Inventor: Gregory Westra, Millers, MD (US)

Correspondence Address: Law Office of Gerow Brill, 20 Oakmont Circle, New Freedom, PA, 17349, US

(21) Appl. No.: 12/583,551

(22) Filed: Aug. 21, 2009

Related U.S. Application Data
(60) Provisional application No. 61/189,666, filed on Aug. 21, 2008.

(51) Int. Cl. E06B 1/04; E06B 1/02; E06B 1/60

(52) U.S. Cl. 52/215; 52/745.2; 52/745.16; 52/745.21

(57) ABSTRACT

The invention discloses an insulated buck system for an insulated concrete form ICF) structure having a plurality of extruded channels, a plurality of foam panels; and a plurality of F-connectors wherein the foam panels are inserted within the extruded channels. Pairs of the extruded channels containing foam in between (planks) are coupled to each other by the F-connectors. The structure of the insulated buck system provides and an insulated seal for the window or door installed within the insulated buck system. Additionally mounting plates for mounting items to the insulated buck system are described. A triangular bracing bracket is also disclosed. A kit of parts is described.

### CROSS REFERENCE

This application is related to Provisional Patent Application 61/189,666 filed on Aug. 21, 2008 entitled Buck System hereby incorporated herein by reference.

### FIELD OF INVENTION

This disclosure describes an improved buck system for use within an integrated concrete form (ICF) structure.

### BACKGROUND OF THE INVENTION

This disclosure discusses the use of buck systems within an ICF structures. Examples of an ICF structure include U.S. Pat. Nos. 6,079,176 and 6,351,918 by Westra et al. These patents disclose a system for insulating only the interior surface of a concrete wall to be poured between a pair of interior and exterior wall forms. The system includes horizontally extending elongated tie strips which connect to each of the wall forms to hold the wall forms spaced apart, a single layer of insulation positioned in contact with the interior wall form, and a plurality of connectors for securing the single layer of insulation to only the interior surface of the concrete wall. The connectors include an enlarged head portion which engages the insulation and a web portion of smaller cross section which extends through apertures in the insulation and into the space between the wall forms, the web portion including openings for the passage of concrete therethrough.

Another example if U.S. Pat. No. 6,434,902 ('902) by Westra, hereby incorporated by reference. A conventional method of attaching layers of insulation materials to a poured concrete wall was to frame the wall with wood or plastic framing strips; the framing strips begin secured to the wall by concrete nails or the equivalent. This procedure is labor intensive, time consuming and therefore quite costly.

The system described U.S. Pat. No. 6,079,176 allows the insulation layers to be held in place while the concrete wall is poured which substantially reduces the labor and cost of an insulated wall. However, this system requires the installation of a large number of web connectors and wedges before the wall can be poured. The '902 patent solved all of the above-indicated long-standing problems by using the standard wall ties, which are conventionally used to hold the wall frames in place, and easy to install caps. This system is installed after the pouring and setting of the wall and eliminates the labor of removing the ends of the conventional ties which is a large saving of labor and cost.

When constructing a building, it is frequently desirable to position a window, door, garage door, or other opening, in a structure wall such as a poured concrete wall or in a wall made from concrete using an insulated concrete form. Procedures for forming an opening have included manufacturing a frame from wood and positioning the frame within a pair of forms used for forming a concrete wall or insulated concrete forms used for forming an insulated concrete wall. Typically, the frame is positioned between the pair of forms after which the concrete is poured into the form and about the frame. Therefore, the desired opening is defined in the wall when the concrete hardens or cures. Thereafter, the window form has been removed and replaced with structure that is used to size the opening and to provide structure for receiving and attaching the window unit itself.

U.S. Pat. No. 4,430,831 (hereby incorporated herein by reference) discloses a window buck formed of a series of sides or channels joined together with nails in an end-to-end relationship to define a rectangular opening. The window buck is a window form which is assembled and positioned so that concrete may be poured around it. U.S. Pat. No. 4,589,624 (Jones) (hereby incorporated by reference) also shows a window buck which is provided for forming a window opening in a cast concrete wall. The buck is removable after the concrete wall is formed in order to proceed with further installation of a window.

U.S. Pat. No. 5,169,544 (Stanfill et al.) (hereby incorporated herein by reference) also describes a buck for use in construction. The buck has internal bracing so that it does not deform or change dimension when the concrete wall is poured about it.

In order to facilitate construction, it would be desirable to have a frame such as and including a window buck which can be easily assembled on site and which thereafter can be installed and remains in place. The frame would preferably be one that is easily sized and shaped and also which is formed to receive a finished insert such as a door or window after the concrete wall has been poured and cured. It would also be desirable to have a frame that could be used with insulated concrete forms.

Conventional building construction utilizes concrete foundation walls which are normally produced by constructing form walls, pouring concrete into the space between the walls and, upon setting of the concrete, removing the form walls. Finishing materials are then added to the concrete foundation walls as required. Framing members, often made of wood, will then be constructed on top of the foundation walls. Insulation may then be inserted between the framing members and the wall finished inside and out as desired.

More recent building systems involve the use of insulated concrete forms (ICF's) which comprise a foam insulating material to construct permanent concrete form walls. The form walls are constructed by placing separate building components upon each other. The concrete is then poured and the form walls are left in place, even after the concrete hardens. The concrete wall so formed need not be confined to foundation walls but may comprise all of a building's walls. Generally, no further insulation is necessary, and known finishing materials of all types, including veneer finishes, stucco, gypsum boards, etc., may be applied to the interior and exterior of the wall as required. An example of a particularly advantageous type of ICF appears in U.S. Pat. No. 5,390,459 (Mensen) and U.S. Pat. No. 5,657,600 (Mensen), the disclosures of which are incorporated by reference herein in their entirety. The ICF's of these patents are made from a building component, which includes first and second high density foam sidepanels. The sidepanels are preferably made of expanded polystyrene and are arranged in spaced parallel relationship with their inner surfaces facing each other. Plastic bridging members molded into the sidepanels hold them together against the forces applied by the poured concrete. Each bridging member includes end plates, which line up when the components are stacked to form furring strips for attachment of finishing materials. As these building components are stacked to become an ICF form wall, it becomes necessary to provide block-out systems known in the art as “bucks” to provide openings for installing components, such as windows or doors, within the ICF form wall.

In conventional, pre-ICF, concrete building systems discussed above, wood or metal bucks have been utilized to provide such a block-out opening in the wall. Many of these conventional bucks are removable once the concrete has hardened, similar to the wood forms used in these pre-ICF building systems, and are referred to within the construction art as “reusable bucks”. Examples of reusable buck systems are disclosed in U.S. Pat. No. 2,787,820 (Shields et al.) as well as in U.S. Pat. No. 5,169,544 (Stanfill et al.) (both hereby incorporated herein by reference).

With the advent of the use of stay-in-place forms or permanent concrete formwork, such as ICF's, the current practice has been to build a wooden framed buck to provide an opening in the wall for installing a component, such as a window or a door. This frame is typically constructed from standard-sized lumber such as 2″×12″ or 1″×12″. If left in place after the poured concrete has cured, this wooden frame of the buck provides a fastening surface for the window or door and its finishing trim.

An example of such a known window buck in an ICF wall uses, for example, 2″×12″ lumber to create the top and sides of the buck. The wooden buck retains the concrete and also provides solid attachment surfaces for interior and exterior finishes around the edge of the openings. The bottom of the buck frame may be created with two 2″×4″'s in an arrangement which will provide a slot to allow proper placement and consolidation of concrete below the opening. In order to keep the wood frame properly aligned in the opening within the stacked wall forms, 1″×4″ wood strapping may be fastened to the perimeter facings of the frame. This will ensure alignment of the wall forms with the wood frame. The 1″×4″ strapping may be removed and reused once the concrete has set.

When the wooden buck frame is to be left in the wall, it must be firmly secured to the concrete. The frame may be fastened to the concrete by using fasteners, such as nails or anchor bolts, secured to the frame and left hanging between the sidepanels of the ICF system. The subsequent pouring of wet concrete between the two sidepanels will cause the wet concrete to flow around the fastener and thus aid in holding the frame in place once the concrete has hardened.

The opening formed by a wood buck for a window and door opening typically require supplemental bracing inside the frame to prevent deflection of the wood members under pressure from the poured concrete. This can be accomplished, for example, by placing one or more pieces of lumber in the opening to brace from side to side and/or from top to bottom. Other bracing arrangements commonly used in the building construction arena utilize dimensional lumber (i.e. 2″×4″, 2″×6″ or 2″×8″, for example). Fiber tape has also been utilized to secure, or assist in securing, the attachment of the buck to the form while the concrete is setting.

The wooden construction of these conventional bucks results in a variety of problems because of the inherent qualities of wood. For example, wood may change dimensions over time as a result of variations in humidity and temperature. This results in a common problem known in the construction field as buck shrinkage, which can affect the thermal performance of the wall and the attached component. If the conventional buck frame members undergo buck shrinkage, they may cup, warp and/or twist. This frequently results in cracks in the wall providing opportunities for air infiltration thereby compromising the thermal performance of the walls. Moreover, the use of wooden framed bucks may lead to significant problems resulting from insect infestation. Also, the wood frame has low thermal insulative properties, which is becoming an increasingly significant issue in modern construction.

Current stay-in-place bucks use fasteners such as nails or screws to attach the window, door, or other component to be mounted within the opening to the buck. The fasteners connect the mounted component to the buck and are anchored either within the wooden buck frame itself or within the adjacent concrete of the building wall. While such an attachment method is feasible, it is often difficult to anchor fasteners within the hardened concrete of the building wall. Moreover, the inherent dimensional instability and other detrimental qualities of wood, including those discussed above, can result in undependable alignment of the mounted component within the form wall system, as well as cracking of interior wall finishing, such as dry wall. Moreover, the cost of constructing such wooden retainers in terms of material and labor is high, especially when constructing a large commercial building, or other structure with many wall openings.

As a result of the foregoing problems and disadvantages, there is a need in the building construction art for a more efficient, cost-effective and reliable apparatus and method for forming a framed opening in a poured concrete wall made with permanent concrete formwork, such as ICFs, which will provide dependable containment of wet concrete within the wall during curing, improve the structural stability of the overall building wall system, facilitate the attachment of components, such as windows and doors, within the wall opening, and overcome the problems inherent with currently used wood block-out wall opening systems.

### SUMMARY OF THE INVENTION

Any insulated concrete form (ICF) structure needs to accommodate windows, doors and other openings in the wall structure. Generally these are accomplished by a buck system. This application discloses an insulated buck system having a plurality of extruded channels; a plurality of foam panels; and a plurality of F-connectors. The foam panels are inserted within a pair of extruded channels to create planks. These pairs of extruded channels containing foam panels (planks) are coupled to each other by the F-connectors. The insulated buck system may include one or more bracing bracket(s) for temporary usage to provide rigidity during the installation of the insulated buck system.

The insulated buck system has a unique manner of coupling the insulated buck system to the insulated concrete form structure (ICF) that provides for a stable installation and a well insulated window or door interface with the ICF system. The extruded channels have a first portion for holding the foam panel; a second portion that is inserted into the foam panel; a third portion for supporting a foam portion of an abutting insulated concrete form; and a fourth portion that provides an interface with a poured concrete portion of the insulated concrete form.

The F-connectors have a first portion supporting a first foam panel; and a second portion supporting a second foam panel, with the foam panels being orthogonal to each other.

One or more mounting plates may be attached to the insulated buck system to support items on the wall of an insulated concrete form (ICF) structure. The mounting plate include a rectangular area; a pair pentagon shaped areas; each pentagon shaped area has a circular opening near a triangular shaped end of the pentagon; a rectangular shaped opening at each interface between the pentagon shaped portion and the rectangular portion; and each pentagon shaped portion is bent to be orthogonal in a same direction with respect to the rectangular portion.

In order to provide and maintain a desired rectangular shape during transportation or installation within an insulated concrete foam structure prior to the pouring and solidifying the concrete, one or more triangular shaped corner bracing brackets are fastened to the corners of the insulated buck system. The triangular shaped bracing bracket includes a first and second side each having one or more mounting holes and a first bracing portion coupling a first end of the first and second sides in between and are orthogonal to each other. The third side of the bracket is coupled to another end of said first and second side by a second and third bracing portion.

A kit of parts for an insulated buck system is described as including a plurality of extruded channels; and a plurality of F connectors. The kit of parts may additionally include one or more of triangular shaped bracing brackets. The kit of parts may also include one or more mounting plates. The kit of parts may also include a plurality of foam panels.

A procedure for making an insulated buck system includes the acts of: inserting a first side of a foam panel into a first extruded channel; inserting a second side of the foam panel into the first extruded panel; repeating the insertion of a foam panel into each of a second, third and fourth pairs of extruded channels; inserting a first portion of a first F-connector into a first end of a first extruded channel with foam; inserting a first end of a second extruded channel with foam into a second portion of the first F-connector; inserting a first portion of a second F-connector into a second end of the first extruded channel with foam; inserting a first end of a third extruded channel with foam into a second portion of the second F-connector; inserting a first portion of a third F-connector into a first end of a fourth extruded channel with foam; inserting a first portion of a fourth F-connector into a second end of the fourth extruded channel with foam; inserting a second portion of the third F-connector into a second end of the third extruded channel with foam; and inserting a second portion of the fourth F-connector into a second end of the second extruded panel.

Additional features and advantages of the invention will be set forth or be apparent from the description that follows. The features and advantages of the invention will be realized and attained by the structures and methods particularly pointed out in the written description and claims hereof as well as the appended drawings.

It is to be understood that both the foregoing general description and the following detailed description are exemplary and explanatory and are intended to provide explanation and context for the invention, the scope of which is limited solely by the appended claims.

### BRIEF DESCRIPTION OF THE DRAWINGS

The features, aspects, and advantages of the present invention will become better understood with regard to the following description, appended claims, and accompanying drawings where:

FIG. 1 illustrates an insulated concrete form structure with several insulated buck systems installed;

FIG. 2 illustrates an isometric view of the insulated buck system;

FIG. 3 illustrates an insulated buck system with a triangular shaped bracing bracket in each corner.

FIGS. 4a and 4b illustrate the details of the extruded channel.

FIG. 5 illustrates a front view of an insulated buck system;

FIG. 6 illustrates an end view of the insulated buck system;

FIG. 7(a-c) illustrate an F-connector and its usage.

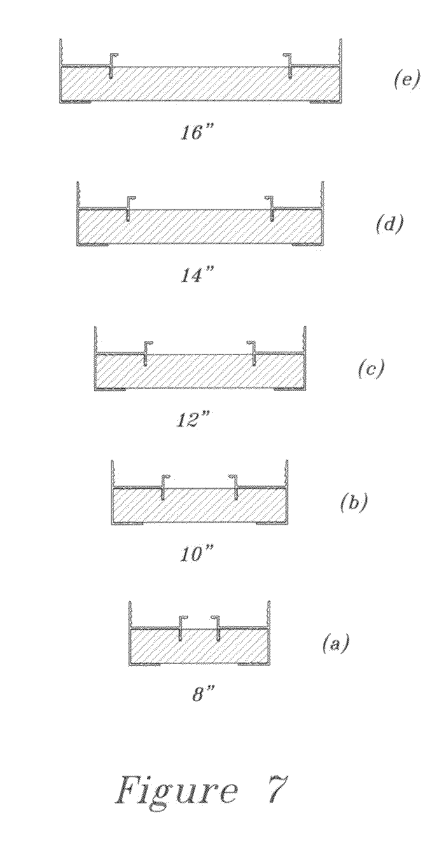

FIG. 8 illustrates a mounting plate;

FIG. 9 illustrates a top view of a mounting plate positioned in a 4″ core;

FIG. 10 illustrates a top view of a mounting plate positioned in a 4″ core and an attachment;

FIG. 11 illustrates a top view of a mounting plate used for bracing a window jamb and sheet rock;

FIG. 12 illustrates a top view of door jamb installation;

FIG. 13 illustrates a top view of center-mount window jamb installation; and

FIG. 14 illustrates details of the triangular shaped bracing bracket.

### DESCRIPTION OF THE INVENTION

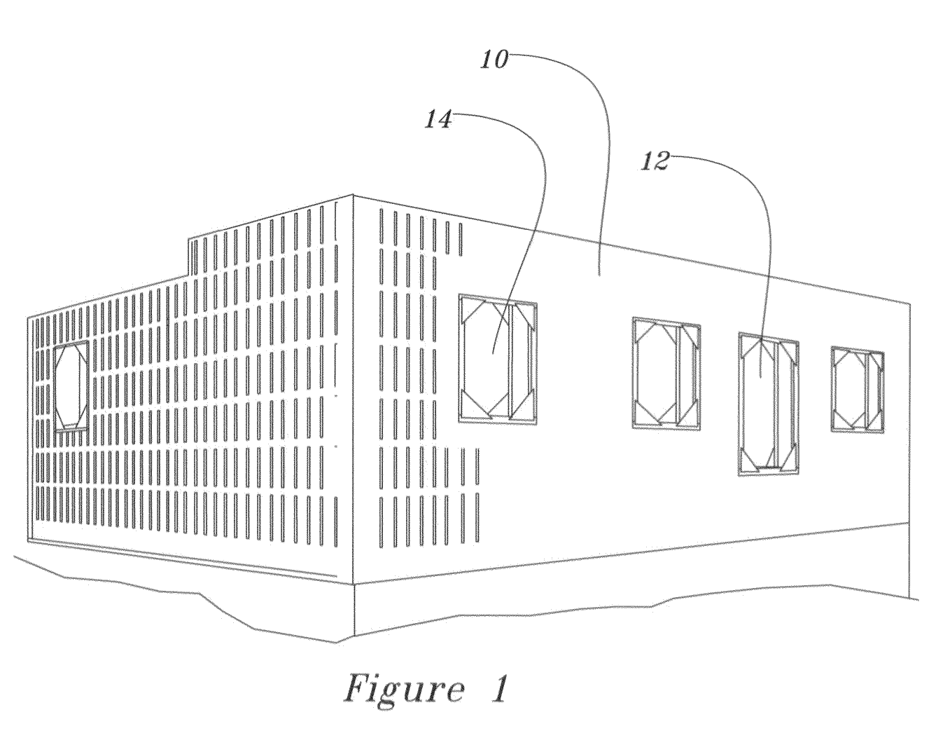

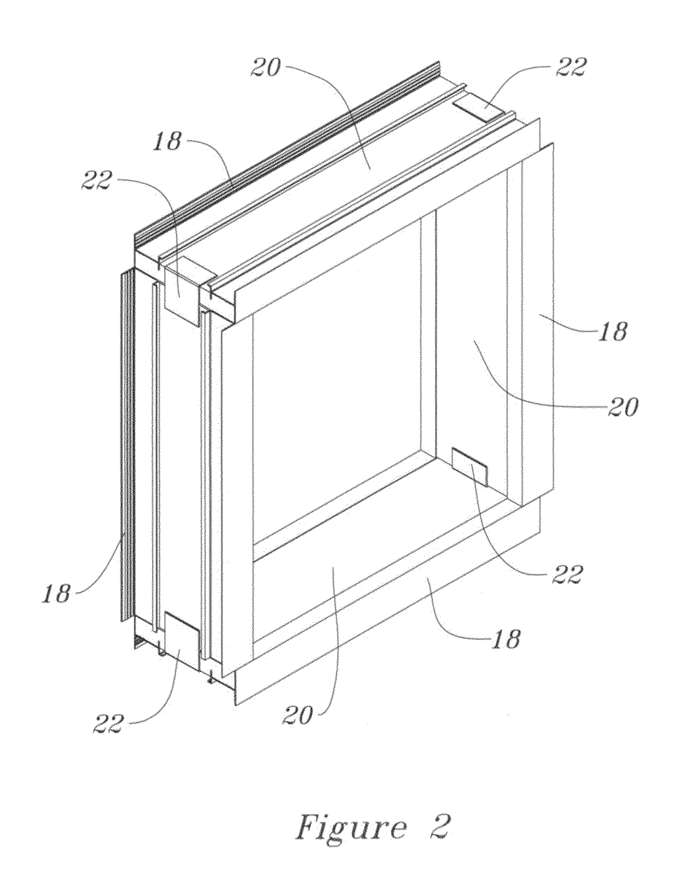

Herein we disclose an improved buck system for use with insulated concrete form (ICF) structures. FIG. 1 illustrates an insulated foam structure 10 with several insulated buck systems installed 12 and 14. FIG. 2 illustrates an isometric view of an insulated buck system 16. The system illustrated in FIG. 2 includes four pairs of extruded channels 18 each with a foam panel 20 supporting a pair of extruded channels 18. An F-shaped extruded connector couples two pairs of extruded channels with a foam panel 20 installed within the pair of extruded channels. Four pairs of extruded channels with their foam panels each pair coupled by an F shaped connector produces an insulated buck system.

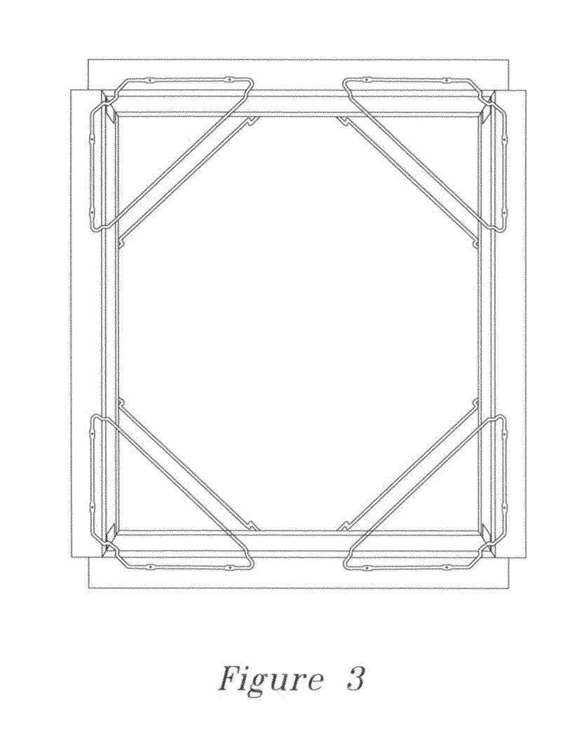

In order to provide a stable rectangular shape, a triangular shaped corner bracing bracket is temporally installed in each corner of an insulated buck system as illustrated in FIG. 3.

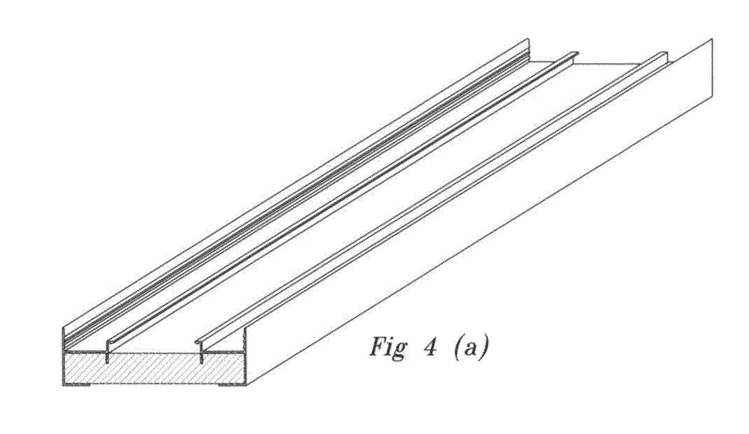

Once the complete insulated buck systems and the other elements of the insulated concrete forms of the structure are finished, the pouring of the liquid concrete begins. The advantages of the claimed insulated buck system become more apparent with the pouring of the concrete. As shown in FIG. 2 each side of the buck has two areas of the extruded channels 18 that match up with insulated foam panels 20 within the structure. The area between the two extruded channels 18 has the foam panel 20 upon which liquid concrete is poured. It is desirable that the extruded channels have a portion that is gripped by the concrete. This provides rigidity and minimizes gaps in the insulation/concrete interface. Importantly, there is a method to prevent any spreading of the extruded channels in the insulation/concrete interface in the ICF system. Details of the shape of the extruded channel are illustrated in FIGS. 4(a) and 4(b). FIG. 4(a) is an isometric view of an extruded channel. FIG. 4(b) illustrates a detailed view of the extruded channel, Sides 30, 32, 26 and 28 enclosing area 34 of one extruded channel 18 provides support for one side of a foam panel 20 and sides 22, 24, 26, and 28 enclosing area 34 of another extruded channel provides support for a second side of a foam panel 20. Portions 38 of sides 36 of each extruded channel 18 provide a means of having the extruded panels to be gripped by the concrete poured between the extruded channels. Sides 40, 36 and 26 enclosing area 42 provides a means of having insulated panel from the insulated concrete form (ICF) structure to connect to the insulated buck system.

Exemplary dimensions for the extruded channels are: side 22, 4.19″; side 26, 2.88″ including a 0.63″ pointed portion 32; and side 28, 2.00″ producing area 34 with a 2.88″width and a 2.00″ height. Area 42 is also 2.88″ wide×2.00″ high. The length of each extruded channel depends upon the size of the window, garage door or other opening to be used. While it advantageous to have on piece of extruded channel on each more than channel piece can be fastened to the foam panel in a serial fashion. An exemplary value of the thickness of the extruded value is 0.125″. The extruded channels are made polyvinylchloride (PVC).

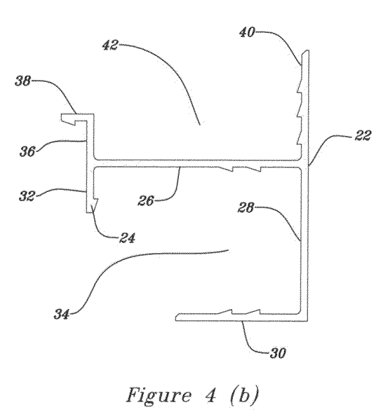

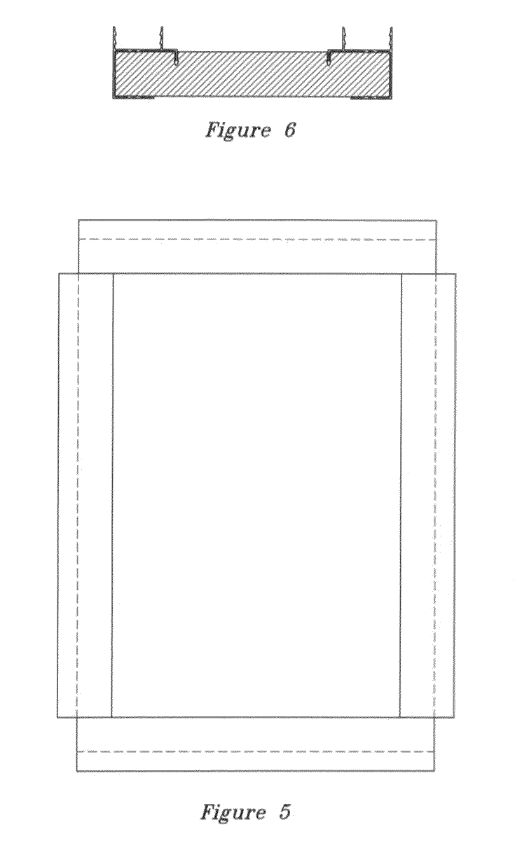

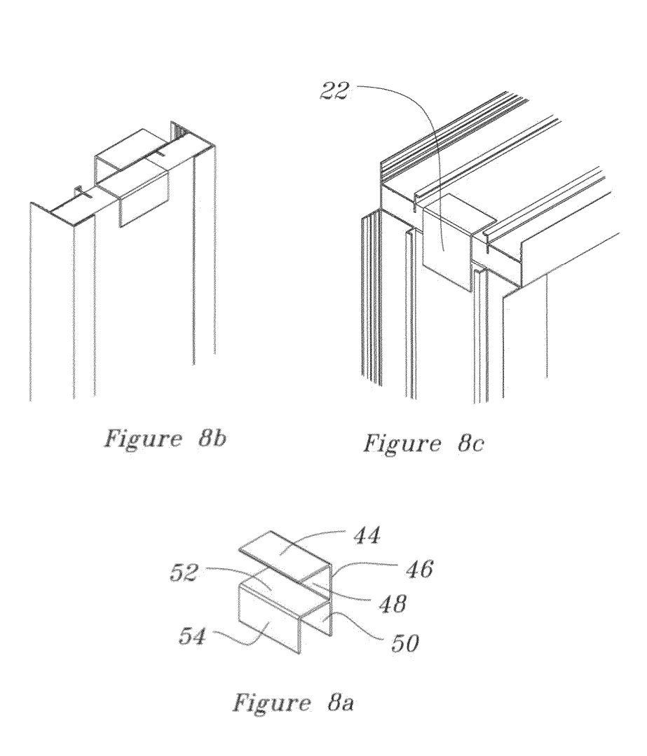

The exemplary size of the foam panels 20 may range from 7.75″ to 18.38″ wide by 2.00″ thick. Each foam panel has a slot 0.13″ wide×0.63 deep, set 2.63″ from each side as illustrated in FIG. 8. These slots are designed to accommodate a portion of side 36 of the extruded channels. FIGS. 5 and 6 illustrate a front and end view of an insulated buck system.

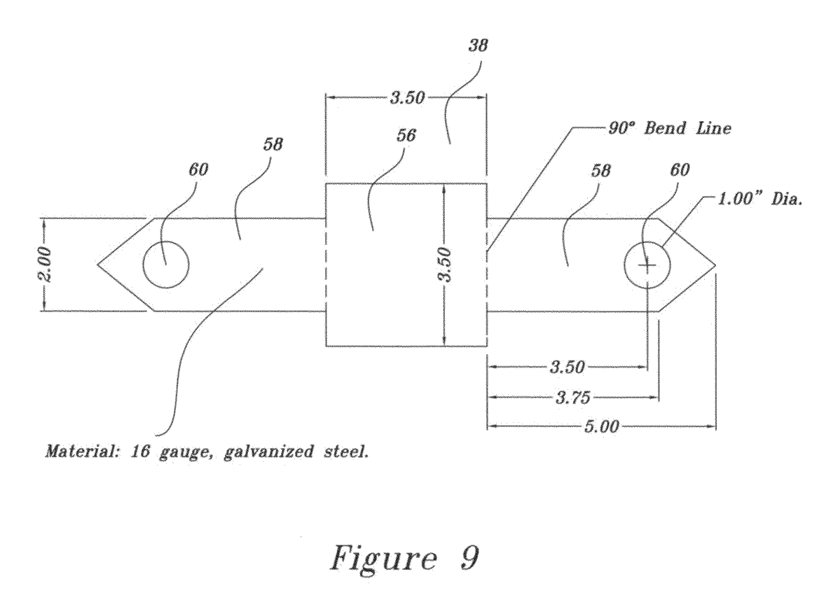

Exemplary dimensions of an F-connector 38 as illustrated in FIG. 9a are: side 44, 2.00″; side 46, 4.19″; side 48, 2.00″; side 50, 2.00″; 52, 2.00″ and side 54, 2.00″. These dimensions are controlled by the size of 2.00″ foam. FIGS. 8b-8d illustrate the installation of an F-channel on the end of a foam panel with its two extruded channels as discussed below.

The method making an insulated buck system to be installed into an insulated concrete form (ICF) structure begins with preparing the top, bottom and sides of the buck system. Each top, bottom or side as illustrated in FIG. 2, includes two extruded channels of the required length to be slid onto a foam panel. For purpose of making the top, bottom and sides, we will refer to the foam panels with their extruded channels as planks. Then place an F-connector on each butt end of a top or bottom plank. Slide the top and bottom planks onto the ends of the side planks. The F-connectors will provide a secure hold. The assembled buck system is braced by installing a triangular shaped corner brace in each corner in order to keep the assembly square and secure for installation within an ICF structure a triangular shaped corner bracing bracket includes a first and second side each having one or more bracing holes and a bracing portion coupling a first end of the first and second side in between and are orthogonal to each other; and a third side coupled to another end of the first and second side by a second and third bracing portion.

As indicated above, the insulated buck system can be used for a window, garage door or an entrance door or other opening within an ICF structure.

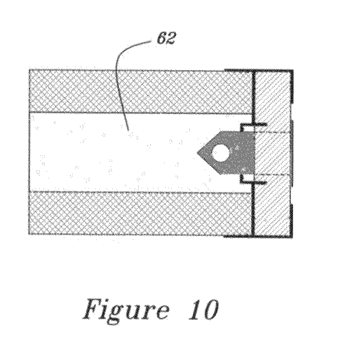

There are times when a mounting plate is needed to be fastened to a foam panel portion of the insulated buck system. The foam by itself does not have the strength needed to support mounted items. Therefore, a mounting plate 36 is used such as illustrated in FIG. 10. The mounting plate 36 includes a rectangular area 56 and a pair of pentagon shaped areas 58. Each pentagon shaped area 58 has a circular opening 60 near a triangular shaped end of the pentagon shaped area 58. There is a rectangular shaped opening 60 at each interface between the pentagon shaped portion and the rectangular portion 56. Each pentagon shaped portion is bent to be orthogonal in a same direction to the rectangular portion. An exemplary mounting plate 36 has a 3.5″×3.5″ rectangular area with two pentagon shaped portions 2.00″ wide and 5.00″ long. The triangle sub-portion of the pentagon shaped portion has a height 1.25″ with a base of 3.5″. The circular opening 60 is typically 1.00″ in diameter with a center located 1.00″ from either edge of the pentagon portion and 1.5″ from the peak of the triangle portion. A 1.00″ rectangular opening is placed at the intersection of the rectangular portion and the pentagon portion. Typically the bracing plate is made of 16 gauge galvanized steel. These dimensions are exemplary and other dimensions may be determined by skilled in the art.

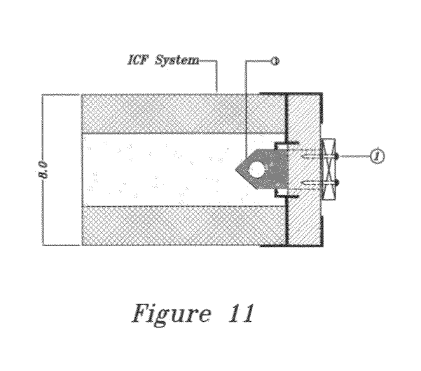

FIGS. 10 and 11 illustrate a general use for the mounting plate 36. FIG. 10 is a top view of an interface between the mounting plate 36 fastened to an insulated buck system that is part of an insulated concrete form system. The foam panels 20 illustrated here are part of the insulated buck system. Foam panel 20 is mounted into two extruded channels 18 as discussed above. The pentagon portions 60 of the mounting plate 36 are punched through the foam panel into the area 62 where liquid concrete will be later poured and hardened. Most of the pentagon portions 58 will be within the concrete area and gripped by the hardened concrete. Item(s) to mounted are mounted to the rectangular portion 56 of the mounting plate are solidly held to the ICF structure by the mounting plate being held by the concrete.

The method of making an insulated buck system first includes the act of preparing the sides of the insulated buck system. Four extruded channels with a length equal to the width of the planned window or other planned opening plus four inches are selected (top and bottom sides). The additional four inches includes the width of the vertical sides that match with the ends of the top and bottom sides as illustrated in FIG. 2. A first foam panel with a length equal to the top and bottom extruded channels is mated up with a first pair of top or bottom extruded channels, thus creating a first plank. A second foam panel with a length equal to the top and bottom extruded channels is mated up with a second pair of top or bottom extruded channel, thus creating a second plank.

Four extruded panels with a length equal to the height of the planned window or other planned opening are selected as vertical side extruded channels. A first foam panel with a length equal to the vertical side extruded channels is mated up with a first pair of vertical extruded channels, thus creating a third plank. A second foam panel with a length equal to the vertical side extruded channels is mated up with a second pair of vertical extruded channels thus creating a fourth plank.

The second portion of making an insulated buck system includes mating the sides of the insulated buck system. The first act may be the inserting a first portion of an F-connector connector into a first end of the first plank. The next act is inserting a first end of a second plank into a second portion of the first F-connector. The next act is inserting a first portion of a second F-connector into a second end of the first plank. The next act is inserting a first end of a third plank into a second portion of the second F-connector. The next act is inserting a first portion of a third F-connector into a first end of the fourth plank. The next act is inserting a first portion of a fourth F-connector into a second end of the fourth plank. The next act is inserting a second portion of the third F-connector into a second end of the third plank. A final act of preparing the basic insulated buck system is inserting a second portion of the fourth F-channel into a second end of the second plank. The order of these acts may be different than above as long as top, bottom and two side planks are in their correct relative positions.

In order to stabilize the insulated buck system for transportation and/or installation within an insulated concrete foam structure (ICF) it may be necessary to install one or more triangular shaped bracing bracket(s) in a corner(s) of the insulated buck system. An exemplary installation of the bracing brackets includes one bracket in each corner of the insulated buck system. Two exemplary sizes of the bracing brackets are 15″ and 21″ depending upon the size of the insulated buck system. These bracing brackets are generally removed from the insulated buck system after placement in the insulated concrete form structure subsequent to concrete placement. An exemplary triangular shaped bracing bracket is illustrated in FIG. 3.

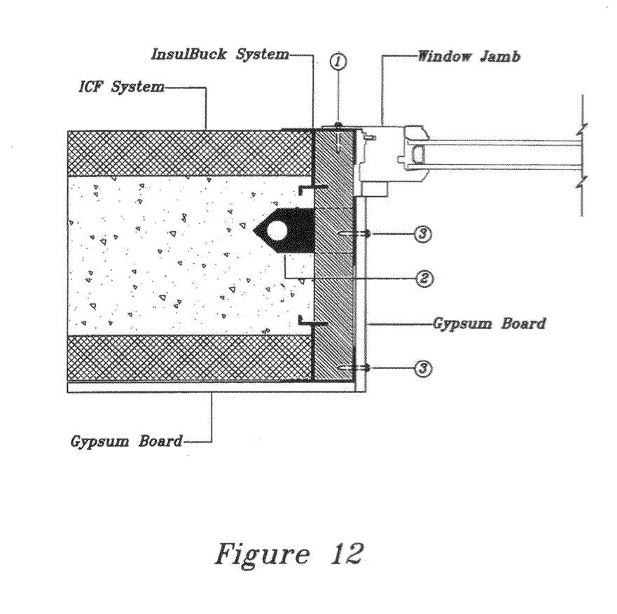

There are several installation methods suggested depending upon the use of the insulated buck system. The first of these is a method of installing a window jamb and fastening gypsum board to an insulated buck system. The first act is securing a window jamb by screwing a window jamb flange directly to an extruded channel. The second act is inserting a mounting plate through an insulated buck system foam prior to placement of concrete; then attaching the gypsum board to an extruded channel using sheetrock screws; and then attaching the gypsum board to the mounting plate using self tapping screws. FIG. 12 illustrates this particular installation.

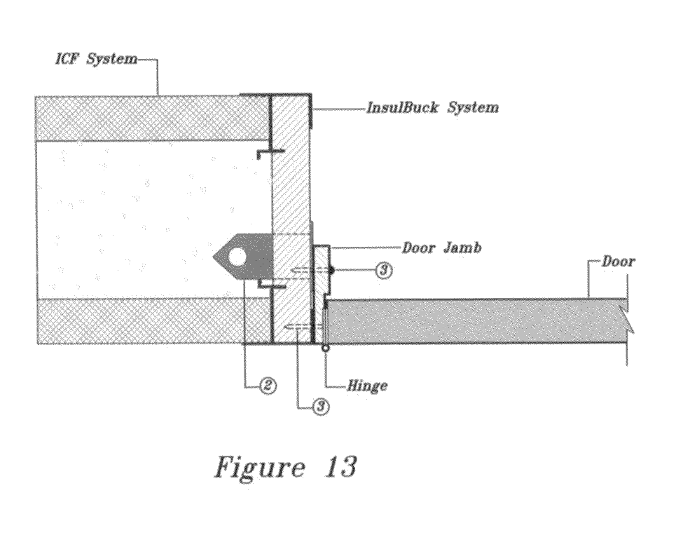

A method of installing a door jamb to an insulated buck system begins with inserting a bracing plate holding close to an extruded channel. The next act is securing the door jamb in place using self-tapping fasteners into the bracing plate. The next acts include securing the jamb directly into the extruded channel and using above steps to both a hinge side and locksite side of the door jamb. FIG. 13 illustrates the bracing a door jamb to an insulated buck system.

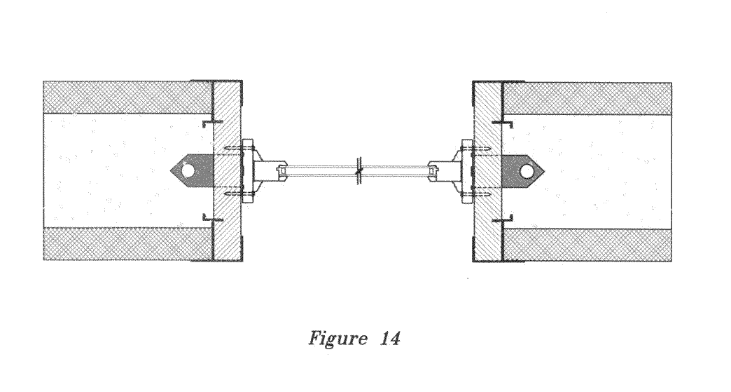

A method of installing a center-mount window jamb to an insulated buck system begins with inserting a bracing plate through the insulated foam system's foam panel where the window jamb is to be mounted prior to placing concrete. After the concrete has cured, one secures the window jamb directly to the bracing plate using self-tapping screws. FIG. 14 illustrates the installation of a center mount window to an insulated buck system.

The elements of an insulated buck system may be delivered as kits of parts to a user to subsequently putting together for a completed insulated buck system. It may be more economical to obtain the foam panels from a local supplier where the other elements are not available locally. A basic kit of parts for a single buck system includes: a plurality of extruded channels; and a plurality of F connectors. A kit of parts may additionally include a plurality of triangular shaped bracing brackets. A kit of parts may additionally include one or more bracing plates. A kit of parts may additionally include a plurality of foam panels. An exemplary basic kit for one insulated buck system includes eight extruded channels and four F-connectors. The eight extruded channels include four extruded channel with a length equal to the planned window width plus 4 inches for use as the top and bottom of the insulated buck and four extruded channels with a length equal to the planned window height. If foam panels are provided within a kit, an exemplary kit would include two foam panels with a length equal to the four extruded channels having a length equal to the planned window width plus four inches and the kit further includes two foam panels having a length equal to the planned window height.

The illustrative embodiments and modifications thereto described hereinabove are merely exemplary. It is understood that other modifications to the illustrative embodiments will readily occur to persons of ordinary skill in the art. All such modifications and variations are deemed to be within the scope and spirit of the present invention as will be defined by the accompanying claims.

I claim:

1. An insulated buck system comprising:
a plurality of extruded channel;
a plurality of foam panels; and
a plurality of F-connectors
wherein said foam panels are inserted within said extruded channels and further wherein a pair of said extruded channels containing foam panels (planks) are coupled to each other by said F-connectors.

2. The insulated buck system of claim 1 further comprising:
one or more mounting plate(s).

3. The insulated buck system of claim 1 wherein said extruded channels comprise:
a first portion for holding said foam panel;
a second portion that is inserted into said foam panel;
a third portion for supporting a foam portion of an abutting insulated concrete form; and
a fourth portion that provides and interface with a poured concrete portion of said insulated concrete form.

4. The insulated buck system of claim 1 wherein said F-connector comprises:
a first portion supporting a first foam panel; and
a second portion supporting a second foam panel, wherein said foam panels are orthogonal to each other.

5. The insulated buck system of claim 2 wherein said mounting plate comprises:
a rectangular area;
a pair pentagon shaped areas;
each pentagon shaped area includes a circular opening near a triangular shaped end of said pentagon;
a rectangular shaped opening at each interface between said pentagon shaped portion and said rectangular portion; and
said each pentagon shaped portion is bent to be orthogonal in a same direction to said rectangular portion.

6. The insulated buck system of claim 1, further comprising a triangular shaped corner bracing bracket.

7. The insulated buck system of claim 1 wherein said triangular shaped bracing bracket comprises:
a first and second side each having one or more bracing holes and a bracing portion coupling a first end of said first and second side in between and are orthogonal to each other; and
a third side coupled to another end of said first and second side by a second and third bracing portion.

8. A kit of parts for an insulated buck system comprising;
a plurality of extruded channels; and
a plurality of F connectors.

9. The kit of parts of claim 8 further comprising one or more of triangular shaped bracing brackets.

10. The kit of parts of claim 8 further comprising;
one or more mounting plates.

11. The kit of parts of claim 8 further comprising:
a plurality of foam panels.

12. The method of making an insulated buck system comprising the acts of:
inserting a first side of a foam panel into a first extruded channel;
inserting a second side of said foam panel into said first extruded panel;
repeating said insertion of a foam panel into each of a second, third and fourth pairs of extruded channels;
inserting a first portion of a first F-connector into a first end of a first extruded channel with foam;
inserting a first end of a second extruded channel with foam into a second portion of said first F-channel connector;
inserting a first portion of a second F-connector into a second end of said first extruded channel with foam;
inserting a first end of a third extruded channel with foam into a second portion of said second F-connector;
inserting a first portion of a third F-connector into a first end of a fourth extruded channel with foam;
inserting a first portion of a fourth F-connector into a second end of said fourth extruded with foam;
inserting a second portion of said third F-connector into a second end of said third extruded channel with foam; and
inserting a second portion of said fourth F-connector into a second end of said second extruded panel.

13. The method of claim 12 further comprising the acts of:
installing one more mounting plates.

14. The method of claim 12 further comprising the acts of:
installing a plurality of triangular shaped bracing bracket(s) in each corner of said insulated buck system.

15. A method of installing a window jamb and fastening gypsum board to an insulated buck system comprising the acts of:
securing a window jamb by screwing a window jamb flange directly to an extruded channel;
inserting a bracing plate through insulated buck system foam prior to placement of concrete;
attaching said gypsum board to extruded channel using sheetrock screws; and
attaching said gypsum board to said bracing plate using self tapping screws.

16. A method of installing a door jamb to an insulated buck system comprising the acts of:
inserting a mounting plate holding close to an extruded channel;
securing a door jamb in place using self-tapping fasteners into said bracing plate;
securing said door jamb directly into said extruded channel and
applying above steps to both a hinge side and locksite side of said door jamb.

17. A method of installing a center-mount window jamb to an insulated buck system comprising the acts of:
inserting a mounting plate through said insulated foam system's foam panel where said window jamb is to be mounted prior to placing concrete;
after said concrete has cured, securing said window jamb directly to said mounting plate using self-tapping screws.
